(19) United States
(12) Patent Application Publication
(10) Pub. No.: US 2024/0345899 A1
(43) Pub. Date: Oct. 17, 2024

(54) DIGITALIZED POWER INDEX FOR AUTOMATIC DVFS OF MULTI-CORE PROCESSOR

(71) Applicant: Media Tek Inc., Hsin-Chu (TW)

(72) Inventor: Shih-Chieh Wang, Hsin-Chu (TW)

(21) Appl. No.: 18/634,269

(22) Filed: Apr. 12, 2024

Related U.S. Application Data
(60) Provisional application No. 63/496,048, filed on Apr. 14, 2023.

(51) Int. Cl. G06F 9/50; G06F 11/34

(52) U.S. Cl. CPC G06F 9/5094; G06F 9/5038; G06F 11/3419

(57) ABSTRACT

A multi-core processor includes a plurality of cores and a central dynamic voltage and frequency scaling (DVFS) system coupled to the plurality of core. The DVFS system is configured to receive power parameters and performance parameters for the plurality of cores. The power parameters may indicate power indices each respective core and the performance parameters may indicate performance for each respective core. The DVFS system may determine a power margin based on a target power budget for the multi-core processor and the power indices for the plurality of cores. For one or more cores of the plurality of cores, the DVFS system may dynamically allocate power to the core by determining an adjusted power index based on the power margin and the performance of the core. Accordingly, the DVFS system may dynamically balance performance and power of the cores.

### CROSS-REFERENCE TO RELATED APPLICATIONS

This application claims the benefit under 35 USC § 119 (e) of U.S. Provisional Application No. 63/496,048, filed Apr. 14, 2023, and entitled “AUTO DVFS FOR MULTI-CORE FRAME BASE SYSTEM”, which is incorporated by reference herein in its entirety.

### BACKGROUND

Multi-core systems comprise a plurality of cores. Each core of a multi-core system may perform different operations.

### SUMMARY

According to aspects of the disclosure, there is provided a method for managing power of a multi-core processor having a plurality of cores, the method comprising, at a central dynamic voltage and frequency scaling (DVFS) system coupled to the plurality of cores, receiving, from the plurality of cores, a set of power parameters respectively indicating power indices of the plurality of cores and a set of performance parameters respectively indicating performance of the plurality of cores, determining a power margin based on a target power budget of the multi-core processor and the power indices of the plurality of cores, and for a core of the plurality of cores, dynamically allocating power to the core by determining a respective adjusted power index based on the power margin and the performance of the core.

In some embodiments, the method further comprises determining the target power budget of the multi-core processor based on reading from a sensor coupled to the multi-core processor and the central DVFS system.

In some embodiments, the performance of a core of the plurality of cores indicates a job completion ratio for a task in the core, the job completion ratio comprising a job ratio over a time ratio, wherein the job ratio comprises a ratio of computations completed over a total computations for the task, and wherein the time ratio comprises a ratio of total execution time for the computations completed over a total of expected execution time for the task in the core.

In some embodiments, determining the respective adjusted power for the core comprises determining whether the performance of the core indicates that a power of the core could be increased, in response to determining that the performance of the core indicates that the power of the core could be increased, determining the respective adjusted power of the core by increasing the power index of the core, and in response to determining that the performance of the core indicates that the power of the core could be decreased, determining the respective adjusted power of the core by decreasing the power index of the core.

In some embodiments, the method further comprises, at the central dynamic voltage and frequency scaling (DVFS) system receiving from the plurality of cores, a set of priority values respectively indicating priorities of the plurality of cores and determining the respective adjusted power of the core is performed in a ranked order according to the set of priority values of the plurality of cores.

In some embodiments, the method further comprises, at a core of the plurality of cores, adjusting power of the core according to the adjusted power for the core obtained from the central DVFS system.

In some embodiments, at the core of the plurality of cores, adjusting the power of the core comprises determining a core power budget for the core based on the power index of the core and the adjusted power index for the core obtained from the central DVFS system and adjusting the power of the core based on the core power budget.

In some embodiments, at the of the plurality of cores, adjusting the power of the core based on the core power budget comprises, when the core power budget for the core indicates there is a power margin, adjusting the power of the core by a first value; otherwise, adjusting the power of the core by a value lower than the first value.

In some embodiments, the method further comprises, at the core of the plurality of cores determining whether the core could be increased a bus frequency, a core frequency, or a combination thereof, based on the determination of whether the core could be increased a bus frequency, a core frequency, or a combination thereof, determining adjusted bus frequency and/or core frequency for the core, and providing the adjusted bus frequency and/or core frequency for the core respectively to an accelerator and/or an internal bus of the core.

In some embodiments, determining whether the core could increase a bus frequency comprises determining a change of utilization rate of the core in a time period, the utilization rate indicating an active ration of an executing unit in the core, determining a change of core clock frequency of the core in the time period, and determining that the core could increase a bus frequency when the change of core clock frequency is greater than a core clock threshold and the change of utilization rate is less than a utilization rate threshold.

In some embodiments, determining whether the core could increase a core frequency comprises determining a change of bandwidth of the core in a time period, the bandwidth indicating amount of data access from an external memory of the multi-core processor per time period, determining a change of bus clock frequency of the core in the time period, and determining that the core could increase a core frequency when the change of bus clock frequency is greater than a bus clock threshold and the change of bandwidth is less than a bandwidth threshold.

According to aspects of the disclosure, there is provided a system comprising a multi-core processor comprising a plurality of cores, a central dynamic voltage and frequency scaling (DVFS) system coupled to the plurality of core processors and configured to receive from the plurality of cores a set of power parameters respectively indicating power indices of the plurality of cores and a set of performance parameters respectively indicating performance of the plurality of cores, determine a power margin based on a target power budget of the multi-core processor and the power indices of the plurality of cores, and for a core of the plurality of cores, dynamically allocate power to the core by determining a respective adjusted power index based on the power margin and the performance of the core.

In some embodiments, the system further comprises a thermal sensor coupled to the multi-core processor and the central DVFS system, the thermal sensor is configured to provide a reading to the central DVFS system, and the target power budget is determined based on the reading from the thermal sensor.

In some embodiments, the performance of a core of the plurality of cores indicates a job completion ratio for a task in the core, the job completion ratio comprising a job ratio over a time ratio, and the job ratio comprises a ratio of computations completed over a total computations for the task, and wherein the time ratio comprises a ratio of total execution time for the computations completed over a total of expected execution time for the task in the core.

In some embodiments, determining the respective adjusted power for the core comprises determining whether the performance of the core indicates that a power of the core could be increased, in response to determining that the performance of the core indicates that the power of the core could be increased, determining the respective adjusted power of the core by increasing the power index of the core, and in response to determining that the performance of the core indicates that the power of the core could be decreased, determining the respective adjusted power of the core by decreasing the power index of the core.

In some embodiments, the central DVFS system is further configured to receive from the plurality of cores, a set of priority values respectively indicating priorities of the plurality of cores and determining the respective adjusted power of the core is performed in a ranked order according to the set of priority values of the plurality of cores.

In some embodiments, the core of the plurality of cores is configured to adjust power according to the adjusted power for the core obtained from the central DVFS system.

In some embodiments, the core of the plurality of cores comprises a respective core DVFS system configured to adjust the power of the core, by determining a core power budget for the core based on the power index of the core and the adjusted power index for the core obtained from the central DVFS system and adjusting the power of the core based on the core power budget for the core.

In some embodiments, at the core of the plurality of cores, the respective core DVFS system is further configured to adjust the power of the core based on the core power budget for the core, by, when the core power budget for the core indicates there is a power margin, adjusting the power of the core by a first value; otherwise, adjusting the power of the core by a value lower than the first value.

In some embodiments, the core of the plurality of cores further comprises a respective core utility monitor circuitry configured to determine whether the core could increase a bus frequency, a core frequency, or a combination thereof and the respective core DVFS system of the core is further configured to, based on the determination of whether the core could increase a bus frequency, a core frequency, or a combination thereof, determine adjusted bus frequency and/or core frequency of the core and provide the adjusted bus frequency and/or core frequency to the core respectively to an accelerator and/or an internal bus of the core.

In some embodiments, determining whether the core could increase a bus frequency comprises determining a change of utilization rate of the core in a time period, the utilization rate indicating an active ration of an executing unit in the core, determining a change of core clock frequency of the core in the time period, and determining that the core could increase a bus frequency when the change of core clock frequency is greater than a core clock threshold and the change of utilization rate is less than a utilization rate threshold.

In some embodiments, determining whether the core could increase a core frequency comprises determining a change of bandwidth of the core in a time period, the bandwidth indicating amount of data access from an external memory of the multi-core processor per time period, determining a change of bus clock frequency of the core in the time period, and determining that the core could increase a core frequency when the change of bus clock frequency is greater than a bus clock threshold and the change of bandwidth is less than a bandwidth threshold.

### BRIEF DESCRIPTION OF THE DRAWINGS

In the drawings, similar or substantially identical components illustrated in various figures may be represented by a like reference character. For purposes of clarity, not every component may be labelled in every drawing. The drawings are not necessarily drawn to scale, with emphasis instead being placed on illustrating various aspects of the techniques and devices described herein.

FIG. 1 is a diagram of an exemplary multi-core processor having access to an external memory, according to some embodiments.

FIG. 2 illustrates an exemplary core system which may be any of the cores in the multi-core processor in FIG. 1, according to some embodiments.

FIG. 3 illustrates a flow chart showing an exemplary policy for adjusting power to the cores that may be implemented in a central DVFS system, according to some embodiments.

FIG. 4 illustrates a flow chart showing an exemplary policy for adjusting power to the cores that may be implemented in a core DVFS system, according to some embodiments.

FIG. 5 illustrates components for determining a maximum power budget, according to some embodiments

FIG. 6 illustrates memory paths, according to some embodiments.

### DETAILED DESCRIPTION

A multi-core processor includes a plurality of cores and a central dynamic voltage and frequency scaling (DVFS) system coupled to the plurality of core. The DVFS system is configured to receive power parameters and performance parameters for the plurality of cores. The power parameters may indicate power indices each respective core and the performance parameters may indicate performance for each respective core. The DVFS system may determine a power margin based on a target power budget for the multi-core processor and the power indices for the plurality of cores. For one or more cores of the plurality of cores, the DVFS system may dynamically allocate power to the core by determining an adjusted power index based on the power margin and the performance of the core. Accordingly, the DVFS system may dynamically balance performance and power of the cores.

A multi-core system may comprise a plurality of cores. Each core in the multi-core system may perform operations, in a manner similar to a frame-based processor. In frame-based processing, data may be processed in frames. Each frame of data may include multiple jobs or multiple sub-jobs grouped together at consecutive times. Within a frame, a respective job or sub-job may belong to a particular channel of an input signal, and each channel may be processed by a particular core. According to some embodiments, frame-based processing can improve the performance because the multi-core system may process multiple jobs or multiple sub-jobs at once, which may reduce processing time or power requirements. Furthermore, frame-based processing may be particularly beneficial in applications where streams of input signal data are parallelized. For example, frame-based processing may be used in applications such as 2D/3D graphics, video processing, and imaging processing.

Multi-core systems may support various job scheduling scenarios. For example, in some scenarios, one job for a particular time may be divided into several sub-jobs, that correspond to respective sub-frames, and each sub-job may be performed by a respective core. In other embodiments, the multi-core system may use a concurrency scenario for multiple jobs. In the concurrency scenario, there may be multiple jobs, and each core may perform a respective job, which may correspond to a respective complete frame.

Multi-core systems described herein may include an automatic DVFS system, which may provide a digitalized power index for performing automatic DVFS. The DVFS systems described herein may provide various benefits. For example, a DVFS system according to aspects of the disclosure may automatically provide a flexible clock rate.

Conventional systems may manually decide DVFS modes, and provide corresponding fixed clock rate (e.g., a performance mode, a balanced mode, or a power saving mode, each with respective fixed clock rates). As a result, the conventional systems may not be able to appropriately balance performance and power, which may have negative impact on the power or performance of the conventional systems. Processors may have discrete frequency and voltage settings to balance power and performance. For conventional processors, frequency and voltage settings may depend on the particular processor, and these conventional processors have little flexibility as to selection of clock frequency operating points. Conventional processors may have a target DVFS level that is pre-defined, and which does not relate to the current status of the processor, which means that conventional processors are often performing jobs while set to a suboptimal DVFS level. For example, conventional processors may simply not know when they should perform DVFS and/or what the target DVFS level is. Instead, conventional processors need to be sent an external command telling the conventional processor to change the DVFS level. Such a configuration requires some external actor other than the conventional processor to detect that the conventional processor needs to speed up to handle more jobs.

In contrast, processors according to the present disclosure themselves are configured to detect that the processor needs to speed up to handle more jobs perform. This provides the processors described herein with the ability to know when they should perform DVFS, as well as to know an appropriate target DVFS level (which the processors described herein can determine based on the current status of the processor).

Furthermore, a DVFS system according to aspects of the disclosure may be able to meet performance goals or requirements without overdriving, which may save more power. The DVFS systems herein may also support multi-core system or heterogeneous computing systems. Additionally, DVFS systems herein allow saved power budget from one core to be provided to other cores. DVFS systems herein may use digitalized indices for power index, job completion ratio (JCR), utilization rate (URate), and bandwidth (BW) information, in order to implement an automatic DVFS system.

Reference will now be made to the drawings to describe the present disclosure in detail. It will be understood that the drawings and exemplified embodiments are not limited to the details thereof. Modifications may be made without departing from the spirit and scope of the disclosed subject matter.

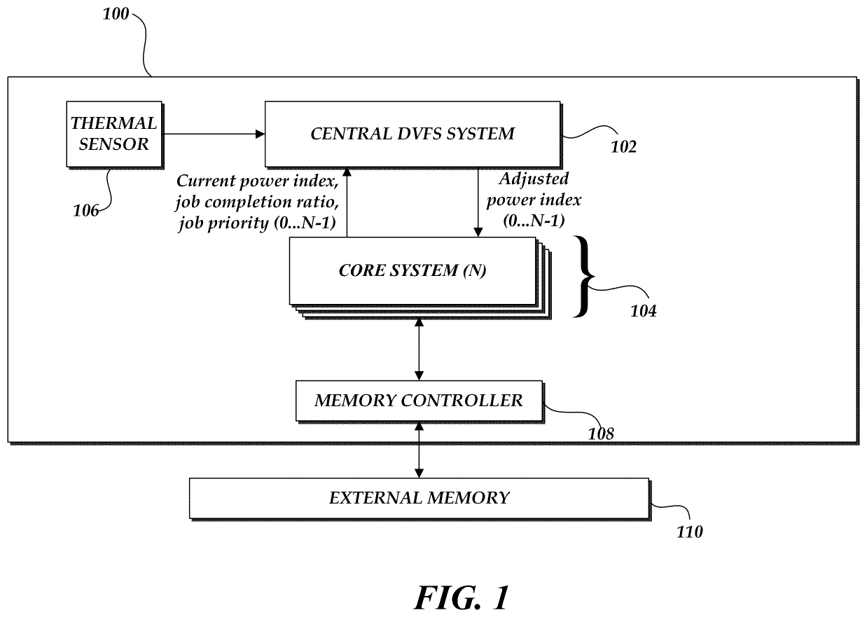

FIG. 1 illustrates an exemplary embodiment of a multi-core system. As shown in FIG. 1, there is a multi-core system 100. Multi-core system 100 may comprise a multi-core processor. Multi-core system 100 comprises a central dynamic voltage and frequency scaling (DVFS) system 102, a core system 104, a sensor 106, and a memory controller 108. The multi-core system 100 may be coupled with an external memory 110.

As shown in FIG. 1, core system 104 may comprise N cores. In some embodiments, the core system 104 may comprise a plurality of cores. Core system 104 may be coupled with central DVFS system 102 and with memory controller 108. The core system may provide the central DVFS system 102 with current power index for one or more of the N cores (from cores 0 to N−1), as well as job completion ratios for the one or more cores, and also job priority for the one or more cores. The core system 104 may also receive, from the central DVFS system 102, adjusted power indices for the one or more cores. As described herein, each core may perform different jobs or sub-jobs in a scheme similar to frame-based processing.

The central DVFS system 102 is configured to provide the core system 104 with adjusted power indices for the one or more cores. As shown in FIG. 1, central DVFS system 102 is coupled with core system 104 and with thermal sensor 106. The central DVFS system 102 may receive information from sensor 106. The central DVFS system 102 may be configured to manage power of a multi-core system 100 (which, as noted above, may comprise a multi-core processor). Accordingly, the central DVFS system 102 may manage a plurality of cores of the multi-core system 100, such as the N cores of the core system 104. The central DVFS system may be coupled to the N cores of the core system 104.

The central DVFS system 102 may perform various functions to manage power of a multi-core system 100. For example, the central DVFS system 102 may receive from one or more the N cores, a set of power parameters that respectively indicate power indices of the plurality of cores, which may comprise a current power index for each of the N cores.

The central DVFS system 102 may further receive from one or more the N cores, a set of performance parameters respectively indicating performance of the plurality of cores, such as job completion ratios for the one or more cores and job priority for the one or more cores. In some embodiments, the performance parameters may comprise a job completion ratio (JCR).

The central DVFS system 102 may use at least some of the power parameters and/or at least some of the performance parameters for the cores to manage the power of the multi-core system 100. For example, the central DVFS system 102 may determine a power margin for multi-core system 100. The power margin may be determined based on a target power budget of the multi-core processor and the power indices of the plurality of cores. In some embodiments, the target power budget may comprise a maximum power budget of the multi-core system representing a maximum amount of power that may be utilized by the multi-core system. For example, power margin may be determined to be equal to a maximum power budget minus a sum of power indices for the plurality of cores. Determination of power index may be performed at respective cores and is described in more detail below.

As noted, the power index may be calculated based on JCR. For example, JCR>1 may indicate that a core is working faster than expected or desired and may be able to slow down. As such, when JCR>1 a new power index may be calculated as an old power index minus a change amount Px. A JCR<1 may indicate that a core is working slower than expected or desired and may be able to speed up. As such, when JCR<1, a new power index may be calculated as an old power index plus a change amount Px. As such, the JCR and job priority for each core may be used to determine power budget. Determination of JCR may be performed at respective cores and is described in more detail below.

For one or more of the N cores of the plurality of cores, the central DVFS system 102 may use the power margin and the performance parameters to allocate power to respective cores. For example, the central DVFS system 102 may dynamically allocate power to one or more of the N cores by determining an adjusted power index for that core based on the power margin and the performance of the core. Furthermore, the central DVFS system 102 may dynamically manage power of multiple cores in a multi-core system 100 by performing this allocation for each respective core.

The central DVFS system 102 may determine an adjusted power for cores. For example, the adjusted power may be determined by calculating a power index for each of the core of the core system 104. The central DVFS system 102 may determine whether the performance of the core indicates that a power of the core should increase (or could be increased). In response to determining that the performance of the core indicates that the power of the core should increase, the central DVFS system 102 may determine the respective adjusted power of the core by increasing the power index of the core. Alternatively, in response to determining that the performance of the core indicates that the power of the core should decrease (or could be decreased), central DVFS system 102 may determine the respective adjusted power of the core by decreasing the power index of the core.

The central DVFS system 102 may determine change of power for cores based on job priority. As such, the central DVFS system 102 may receive from the plurality of cores, a set of priority values respectively indicating priorities of the plurality of cores. The central DVFS system 102 may then determine respective adjusted powers of the cores in a ranked order according to the set of priority values of the plurality of cores. As noted above, each core may have an associated job priority which may be provided as an input to the central DVFS system 102. In some embodiments, the change of power for cores may be performed for each core in a ranked order based on the job priority of that core. Job priority may be per core. In some embodiments, cores may have multiple jobs and therefore multiple priorities. In some embodiments, job priority for each core may be pre-defined and stored in the multi-core system, such as in the central DVFS system.

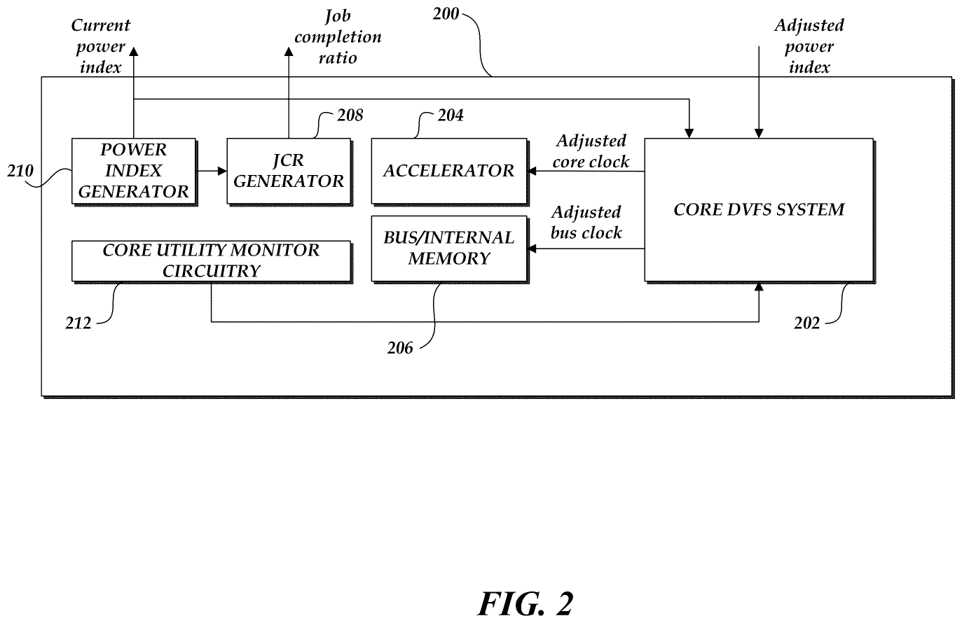

The central DVFS system 102 may provide an output to update the power of one or more of the N cores of the core system 104. For example, the central DVFS system 102 may provide the cores with an output power index to change power for each core. Each core may be configured to adjust its power according to the adjusted power for the core that the core obtains from the central DVFS system. An exemplary core is described in more detail below with respect to FIG. 2.

Sensor 106 is configured to sense information about the core system 100. The sensor 106 is further configured to provide representations of the sensed information to the central DVFS system 102. In various embodiments, sensor 106 may comprise a thermal sensor. The sensor 106 is configured to provide at least one sensor reading to the central DVFS system 102. In some embodiments, the target power budget described above may further be determined based on the reading from the sensor 106. For example, the power budget may be determined based on thermal sensor readings for the multi-core system 100, with higher readings indicating less power is available to be used and lower readings indicating more power is available to be used. Accordingly, a target or maximum power budget of the multi-core system 100 may be determined using a sensor such as a thermal sensor.

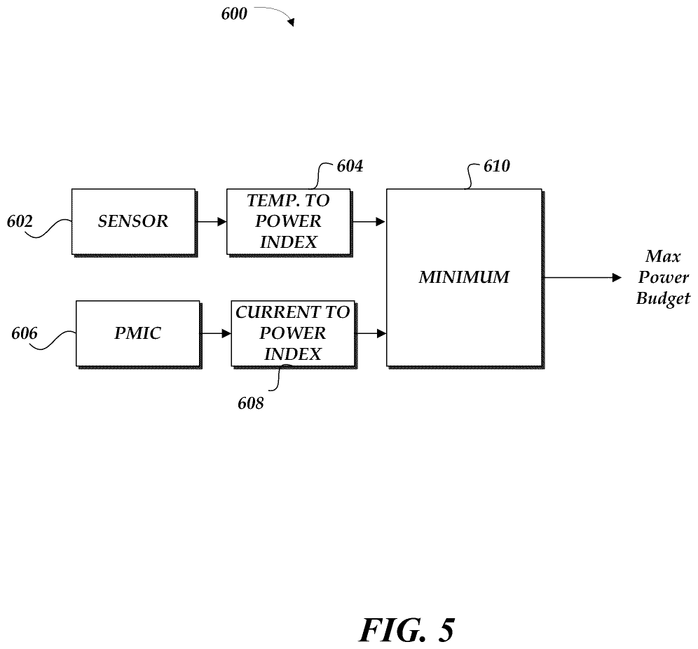

FIG. 5 illustrates another implementation of components for determining a target of maximum power budget, according to some embodiments. In some embodiments, controlling target or maximum power budget may be used only used for temperature limitation, but may also used for current limitation. When target power budget is determined based on readings from a thermal sensor, the target power budget may be controlled for a temperature limitation application in order to provide better apparent temperature. In other embodiments, target power budge may be controlled for ac current limitation application, in order to avoid components from passing too much current (which may cause battery overload or burnout, causing a system auto shutdown. Accordingly, target power budget may be determined based on current in order to avoid violating power management integrated circuit (PMIC) specifications

FIG. 5 shows components 600 for determining a maximum power budget. Components 600 include a sensor 602, a temperature to power index circuitry 604, PMIC 606, current to power index circuitry 608, and minimum circuit 610. Sensor 600 (which may be a thermal sensor) outputs a sensor (e.g., temperature) reading to temperature to power index circuitry 604, which provides a power index to minimum circuitry 610 based on the sensor reading. PMIC 606 outputs a current value to current to power index circuitry 608, which provides a power index to minimum circuit 610 based on the current value. The minimum circuitry 610 then determines a minimum of the power index based on the sensor reading and the current value, and outputs that minimum or a maximum power budget determined based on that minimum

As shown in FIG. 1, memory controller 108 may be coupled with external memory 110. Cores of the core system 104 may access the external memory 110. The amount of data that a core receives from external memory 110 may represent a bandwidth (BW) of the core, which is described in more detail below.

FIG. 2 illustrates an exemplary embodiment of a core system. As shown in FIG. 2, there is a core system 200. In some embodiments, core system 200 may represent an implementation of core system 104. Core system 200 comprises a core DVFS system 202, an accelerator 204, a bus/internal memory 206, a job completion ratio (JCR) generator 208, a power indicator 210, and core utility monitor circuitry 212.

As shown in FIG. 2, the core DVFS system 202 is coupled with the accelerator 204, the bus/internal memory 206, and the core utility monitor circuitry 212. The core DVFS system 202 may receive an adjusted power index. The core DVFS system 202 may receive the adjusted power index externally from the core system 200, for example, from a central DVFS system, such as central DVFS system 102 described with respect to FIG. 1.

One or more of the N cores of the core system 200 (e.g., each core) may include a core DVFS system 202. The core DVFS system 202 may use an obtained power index (e.g., obtained from a central DVFS system such as central DVFS system 102) to adjust the power for the core system 200. To adjust the power of the core system 200, core DVFS system 202 may determine a core power budget (CPB) for the core based on a power index of the core and an adjusted power index for the core obtained from a central DVFS system. The core DVFS system 202 may then adjust the power of the core based on the core power budget for the core. In some embodiments a core DVFS system 202 may use CPB (which may be equal to input power index minus core power index), the computing bound hint, and the bandwidth BW bound hint to set the power of the core.

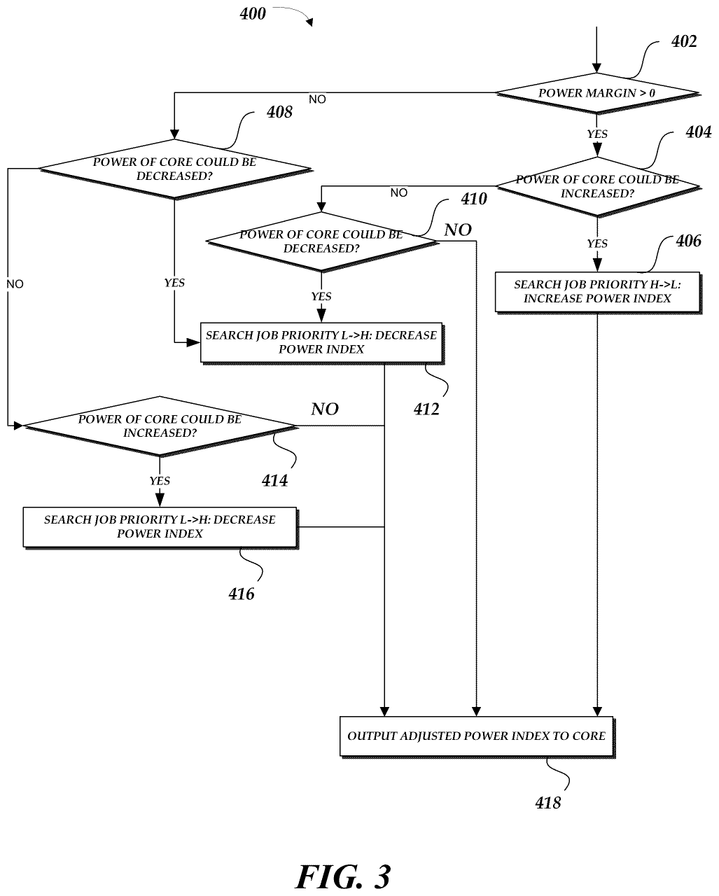

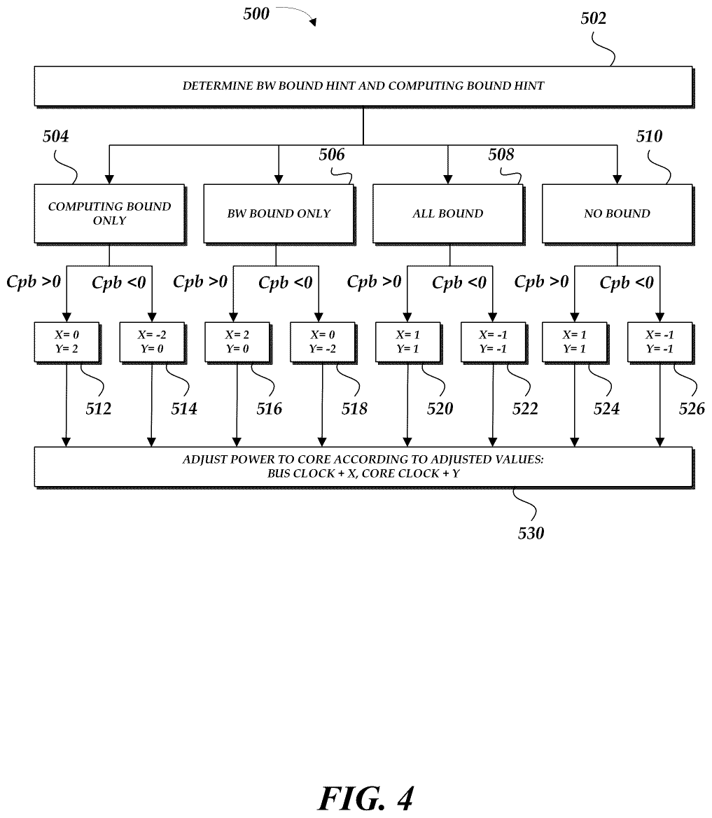

For example, to adjust the power of the core, the core DVFS system 202 may provide an adjusted core clock to the accelerator 204, and/or the core DVFS system 202 may provide an adjusted bus clock to the bus/internal memory 206. Further details for adjusting core power are described below with respect to FIGS. 3 and 4.

As shown in FIG. 2, the accelerator 204 is coupled with the core DVFS system 202. The accelerator 204 may receive the adjusted core clock to the accelerator 204 from the core DVFS system. The accelerator 204 may cause the core system 200 to perform operations based on the core clock frequency.

As shown in FIG. 2, the bus/internal memory 206 is coupled with the core DVFS system 202. The bus/internal memory 206 may receive the adjusted bus clock to the accelerator 204 from the core DVFS system. The bus/internal memory 206 may perform operations based on the bus clock frequency. For example, bus clock may be used for the data transfer from external memory (such as external SRAM) to internal memory (such as internal SRAM), or data transfer from internal memory to external memory. Bus clock may also be used for the CPU to access external memory directly.

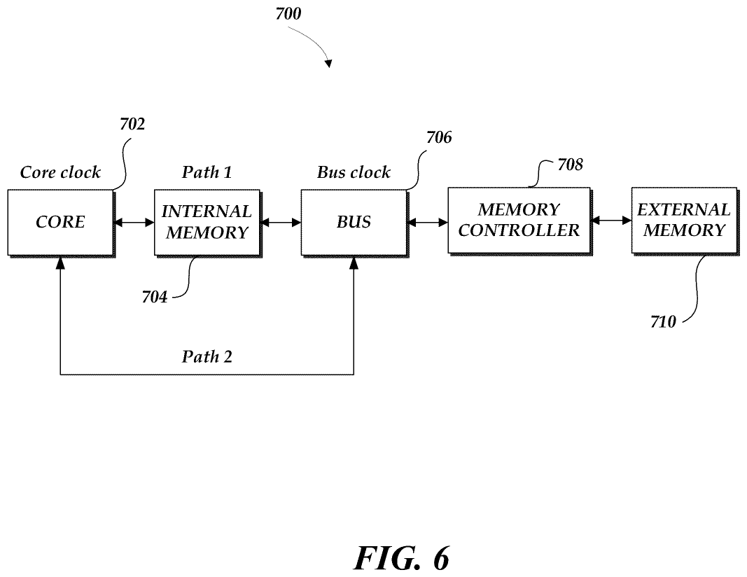

FIG. 6 shows memory paths and associated components 700 associated with a bus. For example, FIG. 6 shows a core 702 (with a core clock), coupled to an internal memory 704, in turn coupled to bus 706 (with a bus clock), in turn coupled to a memory controller 708, in turn coupled to an external memory 710. In some embodiments, the internal memory 704 may use various clock rates. For example, depending on the application, the internal memory 704 may use a clock rate from the core clock or the bus clock, or may use clock rates from both the core clock and the bus clock. In some embodiments, core 702 may be a core of core system 104 or core system 200. Internal memory 704 and bus 706 may comprise the bus internal memory 206. As illustrated by FIG. 6, a core such as core 702 may access external memory may indirectly using path 1 via the internal memory or directly to the external memory using path 2.

As shown in FIG. 2, the JCR generator 208 is coupled with the power indicator 210 and to components external to the core system 200, such as the central DVFS system 102 described with respect to FIG. 1. The JCR generator 208 may receive information from the power index generator 210. The JCR generator 208 may generate a job completion ratio and provide the job completion ratio to components external to the core system 200, such as the central DVFS system 102. As described previously, the performance of a respective core of the N cores of the core system 104 may indicates a JCR for a task in that core. In some embodiments, the JCR may comprise a job ratio divided by a time ratio. The Job ratio may comprise a ratio of computations completed divided by a total computations for the task, and the time ratio may comprise a ratio of total execution time for the computations completed divided by a total of expected execution time for the task in the core. As such, a JCR generator may compute JCR=(completed size/total frame size)×(total exec time/current time), with a JCR>1 indicating that a core could slow down, and a JCR<1 indicating that a core should or could speed up. According to one exemplary embodiment, a JCR for a frame-based core may be generated by determining one or more metrics associated with a number of pixels (e.g., a number of pixels in a frame) that are processed, or alternatively, a number of frames that are processed.

As shown in FIG. 2, the power index indicator 210 is coupled with the JCR generator 208 and to components external to the core system 200, such as the central DVFS system 102 described with respect to FIG. 1. The power index indicator 210 may provide information to the JCR generator 208. The power index indicator 210 may generate a current power index and provide the current power index to components external to the core system 200, such as the central DVFS system 102. For example, power index may be determined by determining a power amount of the core in a particular period of time. The power amount may be determined by based on the functions of the design of the core. Each function may have an associated unit of power for performing the function. The power index indicator 210 may determine how number of active times for each function in the period of time. The number of active times may then be multiplied by the associated unit of power for performing each respective functions, and the multiplication products may be summed to determine the power index. According to merely an illustrative example for determining a power index, a core design has main 3 function, A, B and C. Function A is associated with 3 units of power, function B with 1 unit of power, and function C with 5 units of power. As merely an example, 1 unit may equal 1 mW. The power index indicator 210 determines the power index in a particular period of time. In the particular period of time, the power index indicator 210 determines that function A is performed 7 times, function B, 3 times, and function C 2 times. Accordingly, in the particular period of time, the power index indicator 210 may calculate for the core, that total power index=3×7+1×3+5×2=34 mW.

As shown in FIG. 2, the core utility monitor circuitry 212 is coupled with the core DVFS system 202. The core utility monitor circuitry 212 may provide information to the core DVFS system 202. The core utility monitor circuitry 212 may generate a BW bound hint and/or a computing bound hint may, which may be provided to and used by the core DVFS system 202, as described in more detail below. The BW bound hint may indicate bus frequency is to be increased and the computing bound hint may indicate that core frequency is to be increased. The hints may comprise a binary 1 or 0 indication of whether the frequencies are to be increased. For example, the core utility monitor circuitry 212 may calculate BW/Urate. As such, the core system may use the utility monitor circuitry 212 in order to determine whether the core could increase a bus frequency and/or a core frequency.

The utility monitor circuitry 212 may determine the BW bound hint according to conditions of the core system 200. As noted, the BW bound hint indicates a determination that the core system 200 could increase a bus frequency. The BW bound hint may be determined by determining a change of utilization rate (URate) of the core in a time period (where the utilization rate may indicate an active ratio of an executing unit in the core) and determining a change of core clock frequency of the core in the time period. The utility monitor circuitry 212 may then determining that the core could increase a bus frequency when the change of core clock frequency is greater than a core clock threshold and the change of utilization rate is less than a utilization rate threshold. According to some embodiments, URate may represent an active ratio of the executing unit in a core. For example, 100% URate may indicate that a core is always active in a particular period of time, while a 50% URate may indicate that a core is 50% active in a particular period of time.

According to some embodiments, the utility monitor circuitry 212 may calculate BW bound hint where (URi+1−URi)<URthreshold & (CCi+1−CCi)>CCthreshold. URi represents utilization rate at a time, URi+1 represents utilization rate at a later time, and URthreshold represents a threshold utilization rate change. CCi represents core clock frequency at a time, CCi+1 represents the core clock frequency at a later time, and CCthreshold represents a threshold core clock change.

The utility monitor circuitry 212 may determine the computing bound hint according to conditions of the core system 200. As noted, the computing bound hint indicates a determination that the core could increase a core frequency. The computing bound hint may be determined by determining a change of bandwidth of the core in a time period (where the bandwidth may indicate amount of data access from an external memory of the multi-core processor per time period) and determining a change of bus clock frequency of the core in the time period. The utility monitor circuitry 212 may then determine that the core could increase a core frequency when the change of bus clock frequency is greater than a bus clock threshold and the change of bandwidth is less than a bandwidth threshold. According to some embodiments, BW may represent, at a particular time a total data size (for example, a byte count) that a core has accessed from external memory (such as external memory 110). For example, a BW may be 1 GB/s where a core has received 1 G bytes of data in 1 s.

According to some embodiments, the utility monitor circuitry 212 may calculate computing bound hint where (BWi+1−BWi)<BWthreshold & (BCi+1−BCi)>BCthreshold. BWi represents bandwidth at a time, BWi+1 represents bandwidth at a later time, and BWthreshold represents a threshold bandwidth change. BCi represents bus clock frequency at a time, BCi+1 represents bus clock frequency at a later time, and BCthreshold represents a threshold bus clock change.

According to various embodiments, the threshold change amounts may be set to different values. For example, threshold change amounts for BW, UR, BC or CC may be >0, ==0 or <0 in various embodiments.

FIG. 4 shows an exemplary process flow 400 of operating a multi-core system, such as multi-core system 100. Process flow 400 includes step 402, step 404, step 406, step 408, step 410, step 412, step 414, step 416, and step 418. Process flow 400 may be carried out by a central DVFS system, such as central DVFS system 102. In some embodiments, process flow 400 may be executed for one or more cores, or every core of the multi-core system 100, such that the one or more of the decisions at steps 404, 408, 410, and 414 may be executed for one or more cores, or every core of the multi-core system 100. In some embodiments, process flow 400 may be executed serially or in parallel for multiple cores.

In process flow 400, steps 404, 408, 410, and 414 comprise decision points while steps 406, 412, and 416 comprise power index adjustment points. When performing the process flow 400 for multiple cores, the order of steps may include: first, one or more decision points (steps 404, 408, 410, or 414 comprise); second, a power index adjustment point (steps 406, 412, or 416); and third, moving to a next pass through process flow 400. In a first exemplary case, the process flow 400 may be used to search all cores at the decision points (steps 404, 408, 410, or 414 comprise) and then adjust only one core with a highest or lowest priority at a power index adjustment point (steps 406, 412, or 416), before moving to a next pass through process flow 400. In a second exemplary case, the process flow 400 may be used to search all cores at the decision points (steps 404, 408, 410, or 414 comprise) and then adjust one or more or all cores at one or more power index adjustment points (steps 406, 412, or 416), before moving to a next pass through process flow 400.

As shown in FIG. 4, process flow 400 may start at step 402, where a multi-core system may determine whether a power margin is greater than zero. If the power margin is greater than zero, the process flow 400 may proceed to step 404. If the power margin is not greater than zero, the process flow 400 may proceed to step 408.

At step 404 of process flow 400, the multi-core system may determine whether power of a core could be increased. If the power of the core could be increased, the process flow 400 may proceed to step 406. If the power of the core could not be increased, the process flow 400 may proceed to step 410. As described with respect to FIG. 4, a determination of whether the power of a core could be increased may comprise a check of whether a core's JCR>1. Similarly, as described with respect to FIG. 4, a determination of whether the power of a core could be decreased may comprise a check of whether a core's JCR<1.

At step 406 of process flow 400, the multi-core system may search for job priority from high to low and increase power index. Process flow 400 may then proceed to step 418.

At step 408 of process flow 400, the multi-core system may determine whether power of a core could be decreased. If the power of the core could be decreased, the process flow 400 may proceed to step 412. If the power of the core could not be increased, the process flow 400 may proceed to step 414.

At step 410 of process flow 400, the multi-core system may determine whether power of a core could be decreased. If the power of the core could be decrease, the process flow 400 may proceed to step 412. If the power of the core could not be increased, the process flow 400 may proceed to step 418.

At step 412 of process flow 400, the multi-core system may search for job priority from low to high and decrease power index. Process flow 400 may then proceed to step 418.

At step 414 of process flow 400, the multi-core system may determine whether power of a core could be increase. If the power of the core could be increase, the process flow 400 may proceed to step 416. If the power of the core could not be increased, the process flow 400 may proceed to step 418.

At step 416 of process flow 400, the multi-core system may search for job priority from low to high and decrease power index. Process flow 400 may then proceed to step 418.

At step 418 of process flow 400, the multi-core system may output an adjusted power index to the core.

FIG. 4 shows an exemplary process flow 500 of operating a multi-core system, such as multi-core system 100. Process flow 500 includes step 502, step 504, step 506, step 508, step 510, step 512, step 514, step 516, step 518, step 520, step 522, step 524, step 526, step 528, and step 530. Process flow 500 may be carried out by a core DVFS system such as core DVFS system 202.

As shown in FIG. 4, the process flow 500 may start at step 502, where a multi-core system may determine a bandwidth (BW) bound hint and a computing bound hint. Depending on the determination, process flow 500 may proceed to step 504, step 506, step 508, or step 510.

A core DVFS system 202 may adjust power of its core according to different parameters. At the core system 200 for a respective core, the core DVFS system 202 may adjust the power of the core based on the core power budget for the core. For example, adjusting the power of the core based on the core power budget may comprise, when the core power budget for the core indicates there is a power margin, adjusting the power of the core by a first value; otherwise, adjusting the power of the core by a value lower than the first value. As such, power may be adjusted differently when there is power margin (e.g., when CPB>0) or otherwise (e.g., when CPB<0). Some exemplary embodiments are provided below. For example, the power may be increased or decrease depending on whether when CPB>0 or when CPB<0.

Furthermore, power may be adjusted differently depending on whether the multi-core system is computing bound or bandwidth (BW) bound (e.g., by increasing or decreasing power). Power may be adjusted using a BW bound hint, which may indicate that bus frequency is to be increased. As such, based on the BW bound hint (which represents a determination of whether the core could increase a bus frequency), adjusted bus frequency may be determined.

Power may also be adjusted using a computing bound hint, which may indicate that core frequency is to be increased. Based on the computing bound hint (which represents a determination of whether the core could increase a core frequency), adjusted core frequency may be determined. In some embodiments, both an adjusted bus frequency and an adjusted bus frequency for the core may be determined. BW bound hint and the computing bound hint may be generated by a core utility monitor circuitry (e.g., BW/URate calculator) and provided to core DVFS system 202, as described above.

Following the determination of the adjusted frequencies, the adjusted bus frequency may be provided to the bus/internal memory 206 and the adjusted core frequency may be provided to the accelerator 204. Providing the adjusted bus frequency may to adjust the bus clock of the bus/internal memory 206. Providing the adjusted core frequency may adjust the core clock of the accelerator 204. In some embodiments, when the core frequency is adjusted, the core voltage may also be adjusted. In some embodiments, each core may have its respective frequency and voltage adjusted independently. In other embodiments, each core may have its respective frequency adjusted independently, while voltage adjustments may be shared for the cores. In some embodiments, core voltage and frequency updates may be performed according to a DVFS table.

Exemplary implementations of voltage and frequency determination for multiple cores is now described. For example, each core may have its own DVFS table, with an independent power and clock source. The corresponding frequency value of the clock source may be equal to that of other cores or may be not equal to that of the other cores. Furthermore, the corresponding voltage value of the power source may be equal to that of other cores or not equal to that of other cores.

As another example, each core may have a shared global DVFS table, or each core may have its own DVFS table. In such an arrangement, the cores may have an independent clock source, but shared power sources. The corresponding frequency value of the clock source may be equal to that of other cores or not equal to that of other cores. The corresponding voltage value of the power source may be equal to that of the other cores, because it is a shared power source. In such a configuration, even though the power source is shared, each core may still perform DVFS. In this case, the voltage value may be decided for the power source. For example, one implementation is to maximize each core's voltage value. As merely one example, in a case where there are three cores, a first core may use DVFS level having lower values, e.g., a DVFS “level 3” having a frequency F3 and a voltage V3, a second core may use a DVFS level having intermediate values, e.g., a DVFS “level 5” having a frequency F5 and a voltage V5), and a third core may use a DVFS level having higher values, e.g., a DVFS “level 7” having a frequency F7 and voltage V7. As illustrated higher levels have higher frequency and voltage. In this particular case, the frequency result is that the first core uses frequency F3, the second core uses the frequency F5, and the third core uses the frequency F7. In this case, the voltage result is to use the maximum voltage, which here is the maximum of the voltages V3, V5, V7, which is voltage V7.

Other shared voltage values may be used. Using the maximum voltage is merely one exemplary solution where the power source is shared. As described, this maximum voltage solution may use slower frequency to execute jobs, leading to more time to complete jobs, and therefore higher energy utilization but lower power utilization. In some embodiments, another other solution is to increase the frequency of the first core and the second core when the higher voltage value (e.g., voltage V7) is selected. This solution may have lower energy utilization but a higher power utilization as jobs are cc completed in less time. In other embodiments, a lower than maximum voltage may be selected for better energy consumption while having more power impact.

At step 504, the multi-core system may determine that a core is computing bound only. The process flow 500 may then proceed to step 512 if core power budget (CPB) is greater than zero, or proceed to step 514 if CPB is less than zero.

At step 506, the multi-core system may determine that a core is BW bound only. The process flow 500 may then proceed to step 516 if CPB is greater than zero, or proceed to step 518 if CPB is less than zero.

At step 508, the multi-core system may determine that a core is all bound, in other words, is both computing bound and BW bound. The process flow 500 may then proceed to step 520 if CPB is greater than zero, or proceed to step 522 if CPB is less than zero.

At step 510, the multi-core system may determine that a core is not bound, in other words, in not computing bound or BW bound. The process flow 500 may then proceed to step 524 if CPB is greater than zero, or proceed to step 526 if CPB is less than zero.

At steps 512-526 the multi-core system may determine parameters X for bus clock and Y for core clock. The bus clock and core clock may be determined based on CPB, as a CPB>0 implies JCR<1, while CPB<0 implies JCR>1. At step 512, the multi-core system may determine X=0 and Y=2. At step 514, the multi-core system may determine X=−2 and Y=0. At step 516, the multi-core system may determine X=2 and Y=0. At step 518, the multi-core system may determine X=0 and Y=−2. At step 520, the multi-core system may determine X=1 and Y=1. At step 522, the multi-core system may determine X=−1 and Y=−1. At step 524, the multi-core system may determine X=1 and Y=1. At step 526, the multi-core system may determine X=−1 and Y=−1. Following any of steps 512-526, the process flow 500 may proceed to step 530.

At step 510, the multi-core system may adjust power to core according to adjusted values based on the parameter X and the parameter Y. The multi-core system may determine a new bus clock is equal to an old bus clock plus X. The multi-core system may determine a new core clock is equal to an old bus clock plus Y.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single-or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more circuits (e.g., digital circuits), one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single-or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions implementing the techniques described herein (when implemented as one or more functional facilities or in any other manner) may, in some embodiments, be encoded on one or more computer-readable media, machine-readable media, etc., to provide functionality to the media. Computer-readable media include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium may be implemented in any suitable manner. As used herein, the terms “computer-readable media” (also called “computer-readable storage media”) and “machine-readable media” (also called “machine-readable storage media”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques-such as implementations where the techniques are implemented as machine-executable instructions-the information may be encoded on a computer-readable storage media. Where specific structures are described herein as advantageous formats in which to store this information, these structures may be used to impart a physical organization of the information when encoded on the storage medium.

These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A method for managing power of a multi-core processor having a plurality of cores, the method comprising:
at a central dynamic voltage and frequency scaling (DVFS) system coupled to the plurality of cores:
receiving, from the plurality of cores:
a set of power parameters respectively indicating power indices of the plurality of cores; and
a set of performance parameters respectively indicating performance of the plurality of cores;
determining a power margin based on a target power budget of the multi-core processor and the power indices of the plurality of cores; and
for a core of the plurality of cores, dynamically allocating power to the core by determining a respective adjusted power index based on the power margin and the performance of the core.

2. The method of claim 1, further comprising determining the target power budget of the multi-core processor based on reading from a sensor coupled to the multi-core processor and the central DVFS system.

3. The method of claim 1, wherein the performance of a core of the plurality of cores indicates a job completion ratio for a task in the core, the job completion ratio comprising a job ratio over a time ratio, wherein the job ratio comprises a ratio of computations completed over a total computations for the task, and wherein the time ratio comprises a ratio of total execution time for the computations completed over a total of expected execution time for the task in the core.

4. The method of claim 1, wherein determining the respective adjusted power for the core comprises:
determining whether the performance of the core indicates that a power of the core could be increased;
in response to determining that the performance of the core indicates that the power of the core could be increased, determining the respective adjusted power of the core by increasing the power index of the core; and
in response to determining that the performance of the core indicates that the power of the core could be decreased, determining the respective adjusted power of the core by decreasing the power index of the core.

5. The method of claim 4, further comprising, at the central dynamic voltage and frequency scaling (DVFS) system:
receiving from the plurality of cores, a set of priority values respectively indicating priorities of the plurality of cores;
wherein determining the respective adjusted power of the core is performed in a ranked order according to the set of priority values of the plurality of cores.

6. The method of claim 1, further comprising: at a core of the plurality of cores, adjusting power of the core according to the adjusted power for the core obtained from the central DVFS system.

7. The method of claim 6, wherein, at the core of the plurality of cores, adjusting the power of the core comprises:
determining a core power budget for the core based on the power index of the core and the adjusted power index for the core obtained from the central DVFS system; and
adjusting the power of the core based on the core power budget.

8. The method of claim 7, wherein, at the of the plurality of cores, adjusting the power of the core based on the core power budget comprises:
when the core power budget for the core indicates there is a power margin, adjusting the power of the core by a first value; otherwise, adjusting the power of the core by a value lower than the first value.

9. The method of claim 6, further comprising, at the core of the plurality of cores:
determining whether the core could increase a bus frequency, a core frequency, or a combination thereof;
based on the determination of whether the core could increase a bus frequency, a core frequency, or a combination thereof, determining adjusted bus frequency and/or core frequency for the core; and
providing the adjusted bus frequency and/or core frequency for the core respectively to an accelerator and/or an internal bus of the core.

10. The method of claim 9, wherein determining whether the core could increase a bus frequency comprises:
determining a change of utilization rate of the core in a time period, the utilization rate indicating an active ration of an executing unit in the core;
determining a change of core clock frequency of the core in the time period; and
determining that the core could increase a bus frequency when the change of core clock frequency is greater than a core clock threshold and the change of utilization rate is less than a utilization rate threshold.

11. The method of claim 9, wherein determining whether the core could increase a core frequency comprises:
determining a change of bandwidth of the core in a time period, the bandwidth indicating amount of data access from an external memory of the multi-core processor per time period;
determining a change of bus clock frequency of the core in the time period; and
determining that the core could increase a core frequency when the change of bus clock frequency is greater than a bus clock threshold and the change of bandwidth is less than a bandwidth threshold.

12. A system comprising a multi-core processor comprising:
a plurality of cores;
a central dynamic voltage and frequency scaling (DVFS) system coupled to the plurality of core processors and configured to:
receive from the plurality of cores:
a set of power parameters respectively indicating power indices of the plurality of cores; and
a set of performance parameters respectively indicating performance of the plurality of cores;
determine a power margin based on a target power budget of the multi-core processor and the power indices of the plurality of cores; and
for a core of the plurality of cores, dynamically allocate power to the core by determining a respective adjusted power index based on the power margin and the performance of the core.

13. The system of claim 12, further comprising a thermal sensor coupled to the multi-core processor and the central DVFS system, the thermal sensor is configured to provide a reading to the central DVFS system, wherein the target power budget is determined based on the reading from the thermal sensor.

14. The system of claim 12, wherein the performance of a core of the plurality of cores indicates a job completion ratio for a task in the core, the job completion ratio comprising a job ratio over a time ratio, wherein the job ratio comprises a ratio of computations completed over a total computations for the task, and wherein the time ratio comprises a ratio of total execution time for the computations completed over a total of expected execution time for the task in the core.

15. The system of claim 12, wherein determining the respective adjusted power for the core comprises:
determining whether the performance of the core indicates that a power of the core could be increased;
in response to determining that the performance of the core indicates that the power of the core could be increased, determining the respective adjusted power of the core by increasing the power index of the core; and
in response to determining that the performance of the core indicates that the power of the core could be decreased, determining the respective adjusted power of the core by decreasing the power index of the core.

16. The system of claim 15, wherein the central DVFS system is further configured to:
receive from the plurality of cores, a set of priority values respectively indicating priorities of the plurality of cores;
wherein determining the respective adjusted power of the core is performed in a ranked order according to the set of priority values of the plurality of cores.

17. The system of claim 12, wherein the core of the plurality of cores is configured to adjust power according to the adjusted power for the core obtained from the central DVFS system.

18. The system of claim 17, wherein the core of the plurality of cores comprises a respective core DVFS system configured to adjust the power of the core, by:
determining a core power budget for the core based on the power index of the core and the adjusted power index for the core obtained from the central DVFS system; and
adjusting the power of the core based on the core power budget for the core.

19. The system of claim 18, wherein, at the core of the plurality of cores, the respective core DVFS system is further configured to adjust the power of the core based on the core power budget for the core, by:
when the core power budget for the core indicates there is a power margin, adjusting the power of the core by a first value; otherwise, adjusting the power of the core by a value lower than the first value.

20. The system of claim 19, wherein:
the core of the plurality of cores further comprises a respective core utility monitor circuitry configured to:
determine whether the core could increase a bus frequency, a core frequency, or a combination thereof; and
the respective core DVFS system of the core is further configured to:
based on the determination of whether the core could increase a bus frequency, a core frequency, or a combination thereof, determine adjusted bus frequency and/or core frequency of the core; and
provide the adjusted bus frequency and/or core frequency to the core respectively to an accelerator and/or an internal bus of the core.

21. The system of claim 20, wherein determining whether the core could increase a bus frequency comprises:
determining a change of utilization rate of the core in a time period, the utilization rate indicating an active ration of an executing unit in the core;
determining a change of core clock frequency of the core in the time period; and
determining that the core could increase a bus frequency when the change of core clock frequency is greater than a core clock threshold and the change of utilization rate is less than a utilization rate threshold.

22. The system of claim 20, wherein determining whether the core could increase a core frequency comprises:
determining a change of bandwidth of the core in a time period, the bandwidth indicating amount of data access from an external memory of the multi-core processor per time period;
determining a change of bus clock frequency of the core in the time period; and
determining that the core could increase a core frequency when the change of bus clock frequency is greater than a bus clock threshold and the change of bandwidth is less than a bandwidth threshold.
